(19) United States
(12) Patent Application Publication
(10) Pub. No.: US 2024/0367501 A1
(43) Pub. Date: Nov. 7, 2024

(54) DRIVE TRAIN FOR A WORK MACHINE, AND WORK MACHINE

(71) Applicant: ZF FRIEDRICHSHAFEN AG, Friedrichshafen (DE)

(72) Inventors: Robert MORRISON, Tettnang (DE); Jürgen LEGNER, Friedrichshafen (DE); Eduard HEILIG, Friedrichshafen (DE)

(21) Appl. No.: 18/687,313

(22) PCT Filed: Aug. 30, 2022
(86) PCT No.: PCT/EP2022/074021

§ 371 Date: Feb. 28, 2024

(30) Foreign Application Priority Data
Aug. 30, 2021 (DE) 10 2021 209 463.5

(51) Int. Cl. B60K 6/52; B60K 6/26

(52) U.S. Cl. CPC B60K 6/52; B60K 6/26; B60Y 2200/221

(57) ABSTRACT

A drivetrain of a working machine, including at least a first driven axle and a second driven axle, wherein respective wheels of the first driven axle have a smaller effective diameter than respective wheels of the second axle, an electric traction motor, a transmission, and an axle disengagement device. A drive shaft of the transmission is connected to a driven shaft of the electric traction motor. A first driven shaft of the transmission is connected to a drive shaft of the axle disengagement device. A driven shaft of the axle disengagement device is configured to be connected to the first axle. A second driven shaft of the transmission is configured to be connected to the second axle. The driven shaft of the electric traction motor, the first driven shaft of the transmission and the second driven shaft of the transmission extend in one plane.

### CROSS REFERENCE TO RELATED APPLICATIONS

This application is a U.S. National Phase application under 35 U.S.C. § 371 of International Application No. PCT/EP2022/074021, filed on Aug. 30, 2022, and claims benefit to German Patent Application No. DE 10 2021 209 463.5, filed on Aug. 30, 2021. The International Application was published in German on Mar. 9, 2023 as WO 2023/031157 A1 under PCT Article 21(2).

### FIELD

The present invention relates to a drivetrain of a working machine and a working machine.

### BACKGROUND

In a working machine, such as a backhoe loader with a drivetrain with an internal combustion engine, it is known that the drivetrain can have a driven front axle and a driven rear axle. For this purpose, the front axle and the rear axle are each driven by the combustion engine via a transmission of the drivetrain. The combustion engine requires an oil pan. In order to provide the necessary installation space for the oil pan, a connection between the front axle and the transmission is offset in a vertical direction relative to a connection between the rear axle and the transmission. However, this can reduce the ground clearance of the working machine and thus its off-road mobility.

### SUMMARY

In an embodiment, the present disclosure provides a drivetrain of a working machine, comprising at least a first driven axle and a second driven axle, wherein respective wheels of the first driven axle have a smaller effective diameter than respective wheels of the second axle, an electric traction motor, a transmission, and an axle disengagement device. A drive shaft of the transmission is connected to a driven shaft of the electric traction motor. A first driven shaft of the transmission is connected to a drive shaft of the axle disengagement device. A driven shaft of the axle disengagement device is configured to be connected to the first axle. A second driven shaft of the transmission is configured to be connected to the second axle. The driven shaft of the electric traction motor, the first driven shaft of the transmission and the second driven shaft of the transmission extend in one plane.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic side view of a working machine with a drivetrain according to the prior art; and

FIG. 2 shows a schematic side view of a working machine according to an embodiment of the invention with a drivetrain.

### DETAILED DESCRIPTION

In an embodiment, the present invention relates to a drivetrain of a working machine. The working machine can be configured as a vehicle, for example, as a backhoe loader or as a tractor. The working machine has at least a first driven axle and a second driven axle. One or more wheels can be arranged at each end of each axle, by means of which the working machine can roll over the ground. An axle can have a shaft running in the transverse direction of the vehicle and can be resiliently mounted on a vehicle frame, for example. The first axle can, for example, be configured as a front axle. The second axle can be configured as a rear axle, for example.

Respective wheels of the first axle have a smaller effective diameter than respective

wheels of the second axle. For example, the wheels of the first axle can have a smaller effective diameter than the wheels of the second axle. The different effective diameters can allow better driving characteristics of the working machine. A wheel can be a disk-shaped object. The respective wheels can, for example, make contact with a ground under the working machine with their outer circumference. The wheels of an axle can each have a uniform effective diameter. The effective diameter can correspond to a radius from an axis of rotation of the wheel to a contact surface with the ground. The effective diameter can correspond to a maximum diameter of the wheel. The effective diameter can correspond to a diameter of the wheel under load and thus under elastic deformation. The driven axles can be configured with their wheels to transmit a driving power of the drivetrain to the ground. For example, the drivetrain can be configured as an all-wheel drivetrain. Due to the different effective diameters of the wheels, an axis of rotation of the first driven axle can be offset from an axis of rotation of the second driven axle in the vehicle's vertical direction. The first driven axle can be arranged parallel to the second driven axle, at least when driving straight ahead.

The drivetrain has an electric traction motor, a transmission and an axle disengagement device. The electric traction motor can be configured to provide a driving power for the working machine. The working machine can therefore be configured as an electrically driven working machine. In addition, the traction motor can also be configured to provide power for actuating the respective tools of the working machine.

The transmission can be configured to transmit a driving power provided by the traction motor. The transmission can be configured to provide different gears in a shiftable manner, each of which requires a different gear ratio. For example, a speed provided by the traction motor can be transmitted into a higher or lower speed by the transmission. The transmission can have one or more shifting elements for shifting the gears, such as friction clutches or positive clutches.

The axle disengagement device can be configured to interrupt the transmission of the driving power from the traction motor to one of the driven axles, for example the first driven axle. The axle disengagement device can have one or more switching elements for actuating the axle disengagement, such as friction clutches or positive clutches. This allows an all-wheel drive function of the drivetrain to be switched on and off. In this way, the efficiency of the drivetrain can be increased during journeys where no all-wheel drive function is required, such as on a road, and alternatively or additionally wear, in particular of the respective wheels when cornering, can be reduced. The axle disengagement device can, for example, be arranged between the transmission and the driven axle in the power flow from the engine to the driven axle whose connection with the traction motor can be interrupted via the axle disengagement device. The axle disengagement device can be actuated pneumatically or hydraulically, for example by means of a valve block.

A drive shaft of the transmission is connected to a driven shaft of the traction motor. The drive shaft of the transmission can be an input shaft, at which the driving power for transmitting can be provided. The driven shaft of the traction motor can be an output shaft of the traction motor, at which the driving power can be provided by the traction motor.

A first driven shaft of the transmission is connected to a drive shaft of the axle disengagement device. The first driven shaft of the transmission can be an output shaft of the transmission, at which at least part of the transmitted driving power can be provided by the transmission, for example, for transmitting to the first driven axle. The drive shaft of the axle disengagement device can be an input shaft, to which the part of the driving power can be provided, in particular for separable transmitting to the first driven axle.

An driven shaft of the axle disengagement device is configured to be connected to the first axle. The driven shaft of the axle disengagement device can be an output shaft of the axle disengagement device, at which the part of the driving power transmitted to the axle disengagement device can be provided, for example, for transmitting to the first driven axle. This power can only be provided at the output shaft of the axle disengagement device, for example, if the axle disengagement is not activated.

A second driven shaft of the transmission is configured to be connected to the second axle. The second driven shaft of the transmission can be an output shaft of the transmission, at which at least part of the transmitted driving power can be provided by the transmission, for example, for transmitting to the second driven axle. For example, that part of the total driving power provided by the traction motor to the transmission that is not provided to the first driven shaft of the transmission can be provided to the second driven shaft of the transmission.

The drivetrain can have the first driven axle and the second driven axle. In this case, the driven shaft of the axle disengagement device can be connected to the first axle and the second driven shaft of the transmission can be connected to the second axle. In addition, the drivetrain can have one or more differentials. The differentials can be configured as limited-slip differentials, for example.

The driven shaft of the traction motor, the first driven shaft of the transmission and the second driven shaft of the transmission extend in one plane. An arrangement of a respective shaft can be defined by its axis of rotation. For example, the extent of a shaft can correspond to the axis of rotation. The axis of rotation of a shaft can correspond to its longitudinal axis and alternatively or additionally to its central axis. The plane can, for example, extend in the transverse direction of the vehicle and alternatively or additionally in the longitudinal direction of the vehicle. A large ground clearance can be made possible by the common arrangement in one plane. Thereby advantage is taken of the fact that an electric traction motor does not require an oil pan, around which the connection of one of the driven axles, for example the front axle, has to be routed. This means, for example, that no cardan shaft needs to be connected to the transmission offset downwards relative to another cardan shaft. Thus, a respective connecting area for the first driven axle and the second driven axle can be offset in the transmission, for example, in the transverse direction of the vehicle instead of in the vertical direction of the vehicle. At the same time, despite the different sized wheels on the two driven axles, an angle of the cardan shafts for connecting the respective driven axles to the transmission can be minimized.

Each component can be configured to transmit a torque from its drive shaft to its driven shaft and/or driven shafts. The torque can correspond to the driving power. Two shafts can be connected by a mechanical connection, for example by means of a flange. The connection of one shaft to another shaft can cause these two shafts to move in essentially the same way. A connecting area of a shaft for connecting to another shaft can, for example, be configured to enable a form-fit fastening, for example by means of a screw connection.

For example, a connecting area of the first driven shaft of the transmission can be aligned in the opposite direction to a connecting area of the second driven shaft of the transmission, in particular in the plane. The connecting area of the first driven shaft of the transmission can, for example, point forwards in the longitudinal direction of the vehicle and the connecting area of the second driven shaft of the transmission can point backwards in the longitudinal direction of the vehicle. This allows a simple and direct connection of the two driven axles to the transmission.

In an embodiment of the drivetrain it is provided that the drive shaft of the transmission also extends in the plane. This allows a simple and symmetrical arrangement to be achieved. In addition, the transmission can thus have a simple and cost-effective configuration. For example, all shafts of the transmission can be arranged parallel to each other and alternatively or additionally in the plane.

In an embodiment of the drivetrain it is provided that the drive shaft of the axle disengagement device also extends in the plane. In an embodiment of the drivetrain it is alternatively or additionally provided that the driven shaft of the axle disengagement device also extends in the plane. This allows a simple and symmetrical arrangement to be achieved. In addition, the axle disengagement device can thus have a simple and cost-effective configuration. For example, all shafts of the axle disengagement device can be arranged parallel to each other and alternatively or additionally in the plane. For example, the axle disengagement device can have only coaxial shafts and thus be particularly compact. For example, the axle disengagement device can be arranged coaxially to the transmission, provided that the drive shaft of the axle disengagement device and the driven shaft of the axle disengagement device extend in the plane.

In an embodiment of the drivetrain, it is provided that respective shafts of the drivetrain extending in the plane are arranged axially parallel to each other. This can result in a radially compact configuration of the drivetrain. In addition, the configuration of the drivetrain can be simple and transverse loads can be reduced.

In an embodiment of the drivetrain it is provided that the first driven shaft of the transmission is arranged coaxially to the driven shaft of the traction motor. In addition, the second driven shaft of the transmission can be arranged offset to the first driven shaft of the transmission. For example, the first driven shaft of the transmission can be arranged offset in the transverse direction of the vehicle parallel to the second driven shaft of the transmission. This configuration results in a large ground clearance and, at the same time, a simple connection of the traction motor. This arrangement is particularly advantageous if the traction motor is arranged on a side of the transmission facing the second driven axle. The traction motor can then be arranged with its driven shaft coaxially to a drive shaft of the transmission. If the traction motor is arranged on a side of the transmission facing the first driven axle, for a simple connection of the traction motor, the second driven shaft of the transmission can, for example, be arranged coaxially to the driven shaft of the traction motor and the first driven shaft of the transmission can be arranged offset to the first driven shaft of the transmission. In both cases, the connection of the transmission to the driven axle, which is arranged on the same side of the transmission as the traction motor, can thus simply be routed laterally past the traction motor, for example in the plane. Offset here can mean that the respective axes of rotation are not arranged coaxially. Alternatively or additionally, the drive shaft of the axle disengagement device can also be arranged coaxially to the first driven shaft of the transmission. Alternatively or additionally, the driven shaft of the axle disengagement device can also be arranged coaxially to the first driven shaft of the transmission.

Alternatively, the first driven shaft of the transmission and the second driven shaft of the transmission can be coaxial and offset to the driven shaft of the traction motor. In this case, the first driven shaft and the second driven shaft can be formed by a common shaft.

In an embodiment of the drivetrain, it is provided that the plane extends in the transverse direction of the vehicle. This makes it possible to achieve an essentially uniform ground clearance in the transverse direction of the vehicle. The transverse direction of the vehicle can be a direction orthogonally to a longitudinal direction of the vehicle. The longitudinal direction of the vehicle can extend from the front to the rear of the working machine. The vertical direction of the vehicle can be orthogonal to this and essentially vertical.

In an embodiment of the drivetrain it is provided that the transmission is configured to provide a neutral position. The neutral position can provide idling. The neutral position can be a gear, in which no torque or only a negligible torque, for example due to synchronization, can be transmitted from the driven shaft of the traction motor to the first driven axle and alternatively or additionally to the second driven axle. In the neutral position, for example, corresponding shift elements of the transmission can be open for this purpose.

In an embodiment of the drivetrain, it is provided that the drivetrain has a control device for the axle disengagement device, whereby the control device is arranged on the transmission. This arrangement allows the axle disengagement device to be easily controlled together with the transmission. For example, the control device of the axle disengagement device and a control device of the transmission can be connected with a common cable harness and alternatively or additionally also to each other for control purposes. For example, the control device can be configured as a valve block, which is mounted on a housing of the transmission or a shift valve block of the transmission. The control device can be mounted on the transmission, for example, by means of a screw connection on the housing of the transmission or the shift valve block of the transmission.

In an embodiment of the drivetrain it is provided that the drivetrain has a parking brake that is integrated in the transmission. The parking brake can block a rotation of the second driven axle and alternatively or additionally of the first driven axle by blocking the second driven shaft of the transmission and/or the first driven shaft of the transmission. The working machine can thus be immobilized. For example, the parking brake can be arranged in a housing of the transmission. For example, a parking brake functionality can be provided by a blocking of respective gear wheels or rotary elements of a planetary wheel set of the transmission or by separate parts, which are configured to switchably block a rotation of the first driven shaft of the transmission and alternatively or additionally of the second driven shaft of the transmission. By integrating the parking brake into the transmission, the drivetrain can be compact and the parking brake itself can be protected without the need for a parking brake housing. In addition, the parking brake can be easily controlled together with the transmission.

In an embodiment of the drivetrain, it is provided that the first driven shaft of the transmission is connected to the drive shaft of the axle disengagement device by means of a first cardan shaft. Alternatively or additionally, the second driven shaft of the transmission can be connected to the second axle by means of a second cardan shaft. A cardan shaft can, for example, be configured as a cardan shaft combination with one or two universal joints. A cardan shaft allows a movable connection between the transmission and the driven axle and can thus, for example, allow a relative movement due to a chassis movement. The connection between the driven axle and the corresponding driven shaft of the transmission can be free of further shafts. The cardan shafts can extend in the longitudinal direction of the vehicle. The cardan shafts can extend transversely to the plane. The first cardan shaft can compensate for an offset of the first driven axle relative to the plane, in particular an offset in the vehicle's vertical direction. The second cardan shaft can compensate for an offset of the second driven axle relative to the plane, in particular an offset in the vehicle's vertical direction. The first cardan shaft can, for example, extend forwards from the transmission in the longitudinal direction of the vehicle. The second cardan shaft can, for example, extend rearwards from the transmission in the longitudinal direction of the vehicle. The second cardan shaft can, for example, extend alongside the traction motor in some areas.

A second aspect of the invention relates to a working machine. The working machine has a drivetrain according to the first aspect. The working machine has at least a first driven axle and a second driven axle. Respective wheels of the first axle have a smaller effective diameter than respective wheels of the second axle. For example, the driven shaft of the axle disengagement device is connected to the first driven axle. For example, the second driven shaft of the transmission is connected to the second axle. Respective further features, embodiments and advantages can be found in the descriptions of the first aspect.

In an embodiment of the working machine it is provided that at least the first driven axle or the second driven axle has a wheel hub transmission. For example, each of the first and second driven axles can each have a wheel hub transmission. For example, one wheel hub transmission can be provided per side or per wheel of an axle. The transmission can be configured to provide the same rotational speed on the first driven shaft and on the second driven shaft and alternatively or additionally the same gear ratio from the drive shaft of the transmission. The wheel hub transmission or the wheel hub transmissions can be configured to compensate for the different effective diameters of the wheels so that they have essentially the same circumferential speed when driving straight ahead. This allows the respective wheels to roll over the ground at the same speed, thus avoiding undesirable slippage.

In an embodiment of the working machine it is provided that the working machine is configured as a backhoe loader. The backhoe loader can have a bucket or other tool at the front. The backhoe loader can have another bucket or another different tool on a boom at the rear. The boom can be pivotable around a vehicle vertical axis. Both buckets and/or tools can be movable upwards and downwards. In this way, a backhoe loader can achieve particularly good off-road mobility, which is especially desirable for this type of working machine with its flexible range of applications.

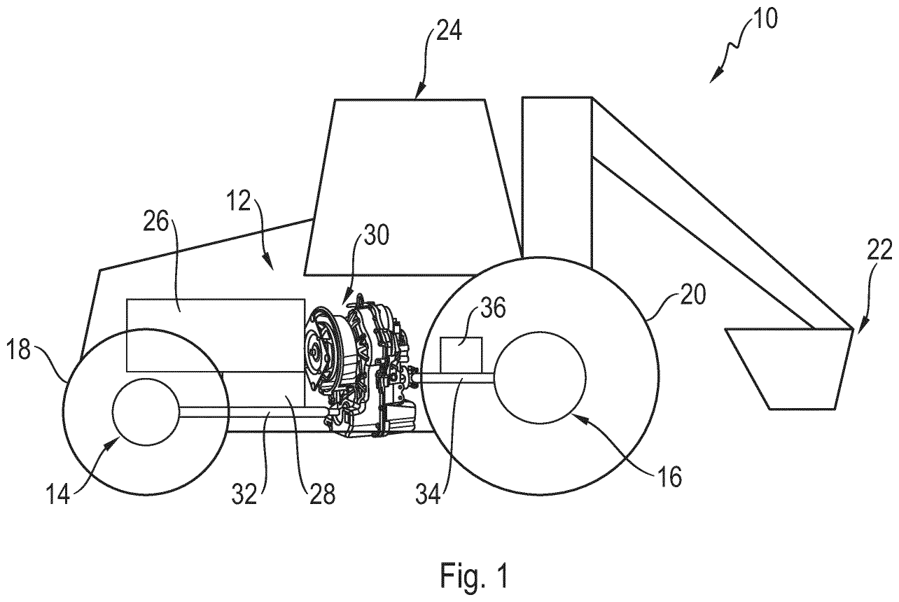

FIG. 1 illustrates a schematic side view of a working machine 10 configured as a backhoe loader according to the prior art. The working machine 10 has an excavator bucket 22 as a tool, which is movably arranged on a rear side of the working machine 10. At the front, the working machine 10 can have a further movable tool. In addition, the working machine 10 has a driver's cab 24.

The working machine 10 has a drivetrain 12 and a front driven axle 14 and a rear driven axle 16. A wheel 18 is arranged at both ends of the front driven axle 14. A wheel 20 is arranged at both ends of the rear driven axle 16. The rear wheels 20 have a larger effective diameter than the front wheels 18. The large rear wheels 20 reduce sinking into soft ground and increase off-road mobility. The smaller front wheels 18 make the working machine 10 more maneuverable.

The drivetrain 12 has an internal combustion engine 26 as a traction motor. The combustion engine 26 supplies the driven axles 14, 16 with a driving power. In addition, the combustion engine 26 can also provide the power for actuating the respective tools of the working machine 10. An oil pan 28 is arranged below the combustion engine 26 in the vertical direction of the vehicle. The vertical direction of the vehicle runs from bottom to top in the image plane. The combustion engine 26 is connected to a drive shaft of a transmission 30 with its driven shaft pointing to the rear in order to transmit the driving power to the transmission 30.

The transmission 30 has a front-side first driven shaft, which is connected to the front driven axle 14 by means of a first cardan shaft 32 for transmitting the driving power. The first driven shaft of the transmission 30 is offset from the drive shaft of the transmission 30 in the vertical direction of the vehicle, so that the cardan shaft 32 can be passed underneath the oil pan 28. In addition, the transmission 30 itself also protrudes far downwards in the vertical direction of the vehicle due to the axle offset to be provided for it. However, this results in a low ground clearance.

The transmission 30 has a rear-side second driven shaft, which is connected to the rear driven axle 16 via a second cardan shaft 34 for transmitting the driving power. The second driven shaft of the transmission 30 is offset from the drive shaft of the transmission 30 and the first driven shaft of the transmission in the vertical direction of the vehicle in order to be arranged at the height of the rear driven axle 16. This requires a complex construction for the transmission 30.

A parking brake 36 is arranged on the second cardan shaft 34, by means of which the second cardan shaft 34 and thus also the rear driven axle 16 can be immobilized. The parking brake 36 has a housing for its protection and is mounted separately in the working machine 10.

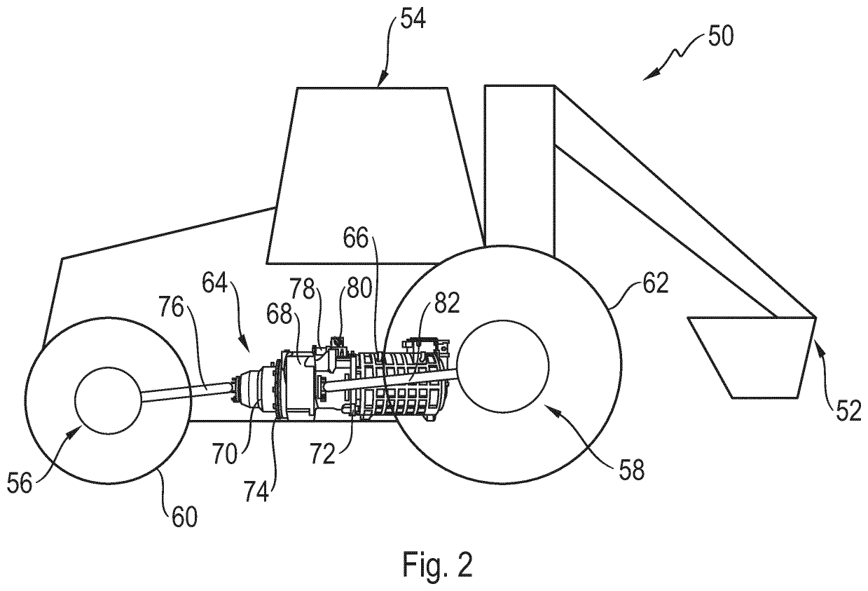

FIG. 2 illustrates a schematic side view of a working machine 50 according to an embodiment of the invention configured as a backhoe loader. The working machine 50 is constructed similarly to the working machine 10 and also has an excavator bucket 52 as a tool, which is movably arranged on a rear side of the working machine 50. The working machine 50 can have a further movable tool at the front. In addition, the working machine 50 has a driver's cab 54.

The working machine 50 also has a front first driven axle 56 and a rear second driven axle 58. A wheel 60 is arranged at both ends of the front driven axle 56. This results in a longitudinal direction of the vehicle, which extends from right to left in the image plane, so that the left corresponds to a front side of the working machine 50 and the right corresponds to a rear side. A wheel 62 is arranged at both ends of the rear driven axle 58. The rear wheels 62 have a larger effective diameter than the front wheels 60. In addition, the working machine 50 has a drivetrain 64, which, however, is constructed differently than in the working machine 10.

The drivetrain 64 has an electric traction motor 66, a transmission 68 and an axle disengagement device 70. The electric traction motor 66 is configured to provide a driving power and can also supply power to respective tools of the working machine 50. As shown, the traction motor 66 is installed horizontally. In another embodiment, the traction motor 66 is installed vertically. The drivetrain 64 is configured to transmit the driving power to the first and second driven axles 56, 58 via the transmission 68. The axle disengagement device 70 is configured to interrupt this transmission to the first driven axle 56 by actuating it. The traction motor 66 is arranged behind the transmission 68 in the longitudinal direction of the vehicle. The axle disengagement device 70 is arranged in front of the transmission 68 in the longitudinal direction of the vehicle.

A drive shaft of the transmission 68 is connected to a driven shaft of the traction motor 66 by means of a flange 72. A first driven shaft of the transmission 68 is connected to a drive shaft of the axle disengagement device 70 by means of a further flange 74. A driven shaft of the axle disengagement device 70 is connected to the first driven axle 56 by means of a flange-mounted first cardan shaft 76. The driven shaft of the traction motor 66, the drive shaft of the transmission 68, the first driven shaft of the transmission 68, the drive shaft of the axle disengagement device 70 and the driven shaft of the axle disengagement device 70 are arranged coaxially to one another.

Furthermore, the transmission 68 has a second driven shaft, which is connected to the second driven axle 58 by a flange-mounted second cardan shaft 82. The second cardan shaft 82 extends to the rear past the traction motor 66 in the longitudinal direction of the vehicle. The second driven shaft of the transmission 68 is arranged parallel to the first driven shaft of the transmission 68 and is offset relative thereto in the transverse direction of the vehicle. The shafts thus lie in a plane formed by the longitudinal direction of the vehicle and the transverse direction of the vehicle. The transverse direction of the vehicle is orthogonal to the image plane shown. In contrast to the drivetrain 12 of the working machine 10, the transmission 68 of the drivetrain 64 of the working machine 50 is thus configured and arranged in such a way that the respective driven shafts are not offset in the vertical direction of the vehicle but in the transverse direction of the vehicle. The first cardan shaft 76 does not have to be passed under an oil pan 28 in the working machine 50. The construction of the drivetrain 64 results in a large ground clearance.

In an embodiment, the first driven shaft of the transmission 68 and the second driven shaft of the transmission 68 are arranged coaxially to each other. In this case, the two driven shafts of the transmission 68 can be formed by a common shaft. In this case, the two driven shafts of the transmission 68 are thus arranged offset in the plane in the transverse direction of the vehicle relative to the drive shaft of the transmission 68 and the driven shaft of the traction motor 66. In this case, the drive shaft of the axle disengagement device 70 is still arranged coaxially to the first driven shaft of the transmission 68.

The transmission 68 can be shifted to a neutral position. This facilitates gear shifting with regard to a mass inertia of the electric traction motor 66. The transmission 68 has a valve block 78 as a control device for shifting respective shift elements of the transmission 68, which is attached to the outside of a transmission housing. In addition, the transmission 68 has a valve block 80 as a control device for the axle disengagement device 70, which is mounted on the outside of the transmission housing or the valve block 78.

The transmission 68 has an integrated parking brake. Accordingly, no separate mounting and no separate housing for the parking brake is required for the drivetrain 64.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

10 working machine
12 drivetrain
14 first axle
16 second axle
18 wheels
20 wheels
22 excavator bucket
24 driver's cab
26 traction motor
28 oil pan
30 transmission
32 cardan shaft
34 cardan shaft
36 parking brake
50 working machine
52 excavator bucket
54 driver's cab
56 first axle
58 second axle
60 wheels
62 wheels
64 drivetrain
66 traction motor
68 transmission
70 axle disengagement device
72 flange
74 flange
76 cardan shaft
78 valve block
80 valve block
82 second cardan shaft

1. A drivetrain of a working machine, comprising:
at least a first driven axle and a second driven axle, wherein respective wheels of the first driven axle have a smaller effective diameter than respective wheels of the second axle;
an electric traction motor;
a transmission; and
an axle disengagement device,
wherein a drive shaft of the transmission is connected to a driven shaft of the electric traction motor,
wherein a first driven shaft of the transmission is connected to a drive shaft of the axle disengagement device,
wherein a driven shaft of the axle disengagement device is configured to be connected to the first axle,
wherein a second driven shaft of the transmission is configured to be connected to the second axle, and
wherein the driven shaft of the electric traction motor, the first driven shaft of the transmission and the second driven shaft of the transmission extend in one plane.

2. The drivetrain according to claim 1, wherein the drive shaft of the transmission also extends in the plane.

3. The drivetrain according to claim 1, wherein the drive shaft of the axle disengagement device also extends in the plane.

4. The drivetrain according to claim 1, wherein the driven shaft of the axle disengagement device also extends in the plane.

5. The drivetrain according to claim 1, wherein respective shafts of the drivetrain extending in the plane are arranged axially parallel to one another.

6. The drivetrain according to claim 1, wherein the first driven shaft of the transmission is arranged coaxially to the driven shaft of the electric traction motor and wherein the second driven shaft of the transmission is arranged offset to the first driven shaft of the transmission.

7. The drivetrain according to claim 1, wherein the plane extends in a transverse direction of the vehicle.

8. The drivetrain according to claim 1, wherein the transmission is configured to provide a neutral position.

9. The drivetrain according to claim 1, wherein the drivetrain comprises a control device for the axle disengagement device, and wherein the control device is arranged on the transmission.

10. The drivetrain according to claim 1, further comprising a parking brake, which is integrated into the transmission.

11. The drivetrain according to claim 1, wherein the first driven shaft of the transmission is connected to the drive shaft of the axle disengagement device by a first cardan shaft and wherein the second driven shaft of the transmission is connected to the second axle by a second cardan shaft.

12. A working machine with the drivetrain according to claim 1, wherein the working machine has at least a first driven axle and a second driven axle and wherein respective wheels of the first axle have a smaller effective diameter than respective wheels of the second axle.

13. The working machine according to claim 12, wherein the first axle is arranged offset to the second axle in a vertical direction of the vehicle.

14. The working machine according to claim 12, wherein at least the first driven axle or the second driven axle comprises a wheel hub transmission.

15. The working machine according to claim 12, wherein the working machine is configured as a backhoe loader.
